(19) United States
(12) Patent Application Publication
(10) Pub. No.: US 2022/0019193 A1
(43) Pub. Date: Jan. 20, 2022

(54) ACCELEROMETER-BASED OBJECT POSE DETERMINATION

(71) Applicant: Hewlett-Packard Development Company, L.P., Spring, TX (US)

(72) Inventors: M. Anthony Lewis, Palo Alto, CA (US); William J. Allen, Corvallis, OR (US); Kristopher J. Erickson, Palo Alto, CA (US); Jarrid Wittkopf, Palo Alto, CA (US); Robert lonescu, Palo Alto, CA (US); Douglas Pederson, Corvallis, OR (US)

(73) Assignee: Hewlett-Packard Development Company, L.P., Spring, TX (US)

(21) Appl. No.: 17/299,765

(22) PCT Filed: Apr. 12, 2019
(86) PCT No.: PCT/US2019/027321

§ 371 Date: Jun. 3, 2021

(51) Int. Cl. G05B 19/4099; B29C 64/379; B29C 64/393; B33Y 40/20; B33Y 50/02; B29C 64/165; B33Y 30/00

(52) U.S. Cl. CPC G05B 19/4099; B29C 64/379; B29C 64/393; B33Y 40/20; G05B 2219/49013; B29C 64/165; B33Y 30/00; G05B 2219/35134; B33Y 50/02

(57) ABSTRACT

In one example in accordance with the present disclosure, a system is described. The system includes a movement device to move a mass with an object disposed therein. A receiver of the system receives accelerometer data from at least one accelerometer disposed within the mass in which the object is disposed. A controller of the system determines a pose of the object within the mass based on received accelerometer data.

### BACKGROUND

Additive manufacturing devices produce three-dimensional (3D) objects by building up layers of material. Some additive manufacturing devices are referred to as “3D printing devices” because they use inkjet or other printing technology to apply some of the manufacturing materials. 3D printing devices and other additive manufacturing devices make it possible to convert a computer-aided design (CAD) model or other digital representation of an object directly into the physical object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for accelerometer-based object pose determination, according to an example of the principles described herein.

FIG. 2 is a flow chart of a method for accelerometer-based object pose determination, according to an example of the principles described herein.

FIGS. 3A-3C depict movement of the mass to determine object pose, according to an example of the principles described herein.

FIG. 4 is a block diagram of a system for accelerometer-based object pose determination, according to another example of the principles described herein.

FIG. 5 is a flow chart of a method for accelerometer-based object pose determination, according to another example of the principles described herein.

FIG. 6 is a block diagram of an additive manufacturing system for accelerometer-based object pose determination, according to another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Additive manufacturing systems make a three-dimensional (3D) object through the solidification of layers of a build material on a bed within the system. Additive manufacturing systems make objects based on data in a 3D model of the object generated, for example, with a computer-aided drafting (CAD) computer program product. The model data is processed into slices, each slice defining portions of a layer of build material that is to be solidified.

In one example, to form the 3D object, a build material, which may be powder, is deposited on a bed in a layer-wise fashion. A fusing agent is then dispensed onto portions of the layer of build material that are to be fused to form a layer of the 3D object. The system that carries out this type of additive manufacturing may be referred to as a powder and fusing agent-based system. The fusing agent disposed in the desired pattern increases the energy absorption of the topmost layer of build material on which the agent is disposed. The build material is then exposed to energy such as electromagnetic radiation. The electromagnetic radiation may include infrared light, laser light, or other forms of suitable electromagnetic radiation. Due to the increased energy absorption properties imparted by the fusing agent, those portions of the build material that have the fusing agent disposed thereon heat to a temperature greater than the fusing temperature for the build material.

Accordingly, as energy is applied to a surface of the build material, the build material that has received the fusing agent, and therefore has enhanced energy absorption characteristics, fuses while that portion of the build material that has not received the fusing agent remains in powder form. Those portions of the build material that receive the agent and thus have increased energy absorption properties may be referred to as fused portions. By comparison, the applied energy is not so great so as to increase the energy absorption properties of the portions of the build material that are free of the fusing agent. Those portions of the build material that do not receive the agent and thus do not have increased energy absorption properties may be referred to as unfused portions.

Accordingly, a predetermined amount of energy is applied to an entire bed of build material, the portions of the build material that receive the fusing agent, due to the increased energy absorption properties imparted by the fusing agent, fuse and form the object while the unfused portions of the build material are unaffected, i.e., not fused, in the presence of such application of energy. This process is repeated in a layer-wise fashion to generate a 3D object. That is, additional layers may be formed and the operations described above may be performed for each layer to thereby generate a three-dimensional object. Sequentially layering and fusing portions of layers of build material on top of previous layers may facilitate generation of the three-dimensional object. The layer-by-layer formation of a three-dimensional object may be referred to as a layer-wise additive manufacturing process.

The unfused portions of material can then be separated from the fused portions, and the unfused portions may be recycled for subsequent 3D printing operations. While specific reference is made to one type of additive manufacturing process, the principles described herein may apply to other types of manufacturing processes.

In some examples, these types of manufacturing processes, or others, justify a cleaning operation before the part is ready to use. For example, as a result of the additive manufacturing process, powder from the bed may be caked onto the fused part. For example, even though the amount of energy applied to the powder bed material does not completely fuse unfused portions, the unfused portions may clump together, or “cake.”

Such caking may result for any number of reasons. As a specific example, heat from energy absorbed by fused portions of the build material, may transfer by conduction to immediately adjacent unfused portions of the build material. This is sometimes referred to as thermal bleed and can increase the cost and difficulty in manufacturing 3D printed objects.

For example, after a 3D printed object is formed, unused build material is removed from around the object. Due to the thermal bleed described above, immediately adjacent unfused build material may become temporarily, or semi-permanently, affixed to the object. The objects therefore are to be cleaned of this unfused caked material before they can be used. Removal of this material can be difficult, time-consuming, and in some cases may even damage the 3D printed object.

Such caking increases the overall cost of additive manufacturing as well. For example, during formation, unfused build material can be recycled and re-used in later 3D printing operations. However, when the unfused build material cakes, it is no longer recyclable. Accordingly, it may be desirable to enable automated systems, such as robotic systems to grasp, manipulate, and dean parts hidden in a mass, or “potato” of caked powdered build material.

However, before such 3D printed objects can be grasped and manipulated by these automated systems, the location and orientation of the object within the mass should be determined so that the automated systems can delicately grasp the object without excessive force so as to not damage the part and such that precise cleaning or other post-processing operations can be performed.

Present methods for determining the pose of parts within a mass of build material are clumsy and ineffective. As used in the present specification and in the appended claims, the term “pose” refers to an identification of various positional characteristics of the object. For example, a pose may include a position along three axes (x, y, and z) of a reference frame as well as rotation about those axes (pitch, yaw, and roll).

For example, while the dimensions of all parts in a build area may be identified, a specific part may not be able to be identified relative to the potato that encloses it. Identifying a part within a mass of material may include looking up the intended dimension of the part in the data previously sent to the system and hypothesizing about the hidden part based on the dimensions of the mass. In another example, a mechanical probe may be inserted into the mass to aid in part identification. However, in some cases the parts may be delicate and the probe may cause damage to the part. This may also not be able to detect certain distinguishing characteristics of certain printed objects.

In yet another example, a cage may be added around a 3D printed object. Such cages may carry identification information and orientation fiducials. However, this method reduces overall printer build yield, as precious build volume is allocated away from parts and allocated to the cages. Moreover, there is wasted volume between the cages and the parts. As yet another complication with such a method, the cage itself may also be hidden inside the potato, making the position and orientation of the cage, and the part it encompasses, unknown.

Accordingly, the present specification describes a system and method that has the ability to identify a location of a part inside of an enclosing mass and may also particularly identify the part. Specifically, the present systems and methods add features inside, on the surface of, or nearby to a 3D printed object. The features allow the part to be identified and localized by moving the mass along paths and measuring accelerations experienced by each feature. In this manner, the location and orientation of each feature can be determined. Such identification and localization is enabled even when parts are surrounded by optically opaque material. While specific reference may be made in the present specification to particular types of additive manufacturing processes, the methods and systems described herein may be implemented in accordance with any number of additive manufacturing operations.

Specifically, according to the present specification, accelerometers are placed at predetermined poses relative to a part of interest. Following fabrication, the mass which includes the object-embedded accelerometers is manipulated in a predetermined fashion. Based on information received from the accelerometers in conjunction with the tracked movements of the mass, the position and orientation of the 3D printed object within the mass may be determined such that subsequent post-processing operations may be carried out. Determining the pose of the accelerometers relative to the mass facilitates calculation of the pose of the hidden 3D printed object in the mass. Once the 3D printed object pose within the mass is determined, automated cleaning, or other post-printing operations, are better enabled.

Specifically, the present specification describes a system for determining a pose of an object within a mass. The system includes a movement device to move the mass with the object disposed therein. A receiver of the system receives data from at least one inertial measuring device disposed within the mass in which the object is disposed. A controller of the system then determines a pose of the object within the mass based on received data.

The present specification also describes a method. According to the method, a mass of powdered build material in which a three-dimensional (3D) printed object is concealed, is moved. Acceleration data is received from at least one accelerometer disposed within the mass of powdered build material as the mass is moved. Based on the received acceleration data, a pose of the 3D printed object within the mass of powdered build material is determined.

An additive manufacturing system is also described. The additive manufacturing system includes a build material distributor to deposit layers of powdered build material onto a bed. An agent distributor of the additive manufacturing system selectively distributes a fusing agent onto layers of the powdered build material to selectively solidify portions of a layer of building material to form a slice of a three-dimensional (3D) printed object. A placement device of the additive manufacturing system embeds at least one accelerometer in predetermined locations in a mass of powdered build material that includes the 3D printed object. The additive manufacturing system also includes a recorder to record a pose of the at least one accelerometer relative to the 3D printed object. The recorded pose of the at least one accelerometer within the 3D printed object facilitates determination of the pose of the 3D printed object within a mass of powdered build material.

Such systems and methods 1) allow identification of a part, or object, hidden in encompassing material such as a powdered build material; 2) allow for a determination of the pose of a part hidden in the powdered build material; 3) trigger access to precise data associated with a hidden part, such as dimensional data; 4) trigger subsequent cleaning, assembly, or other operations based on the precisely identified part within the mass; 5) conserves build material by not allocating additional build volume for identification and location information; 6) in some examples precludes incorporation of foreign identification device; and 7) can implement any type of accelerometer. However, it is contemplated that the devices disclosed herein may address other matters and deficiencies in a number of technical areas.

As used in the present specification and in the appended claims, the term “pose” refers to an identification of various positional characteristics of the object. For example, a pose may include a position along three axes (x, y, and z) of a reference frame as well as rotation about those axes (pitch, yaw, and roll).

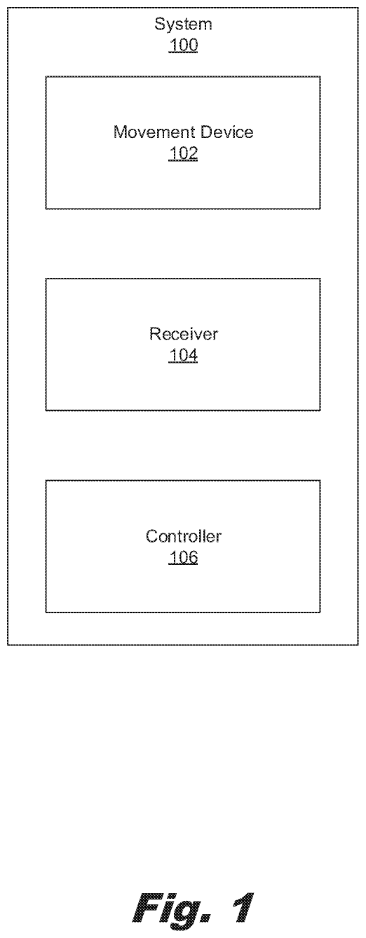

Turning now to the figures, FIG. 1 is a block diagram of a system (100) for object pose determination, according to an example of the principles described herein. In some examples, the system (100) may form part of a post-printing system. For example, once a three-dimensional (3D) object is printed, a mass in which it is disposed may be removed, either manually or by an automated device, from the additive manufacturing system and passed to a post-printing system such as a cleaning station. There, the system (100) may operate to determine the pose of the 3D printed object within the mass such that subsequent operations on the 3D printed object may be carried out.

The system (100) includes a movement device (102) to move the mass of powdered built material with the object disposed therein. That is, as described above, the object disposed inside the mass of powdered build material includes an inertial measuring device, or multiple inertial measuring devices, such as an accelerometer, gyroscope, or magnetometer among others. These inertial measuring devices are disposed on, in or nearby the object. That is the object may have inertial measuring devices on its surface or inside its body. In another example, the inertial measuring devices may not be on the object at all, but rather disposed in the mass surrounding the object.

Throughout the present specification, specific reference may be made to a particular type of inertial measuring device, such as an accelerometer. However, the present systems and methods may be implemented with other inertial measuring devices such as gyroscopes and magnetometers, among others.

These accelerometers output a signal indicative of the acceleration of the object to which they are affixed. For example, the magnitude of the output signal corresponds to the magnitude of acceleration upon the accelerometer as measured along a sensitivity axis of the accelerometer. Accordingly, as these accelerometers are moved, the output data may be used to determine locations and orientations of the accelerometers within the mass. Accordingly, the movement device (102) imparts this motion that generates the outputs of the accelerometers that are used to determine object pose within the mass. While specific reference is made to using multiple accelerometers to determine object pose, the pose of an object within the mass may be determined using a single accelerometer formed in the 3D printed object.

In some examples, the movement device (102) may be a moveable platform on the stage. That is, the movable platform may be able to move in any number of directions. In some examples, the movement device (102) may be a robotic arm that grips the mass and moves it. In this example, the movement device (102) may translate and rotate the mass such that different forces are exerted on the mass and different outputs are recorded.

The system (100) also includes a receiver (104) to receive acceleration data from the at least one accelerometer that is disposed within the mass in which the object is disposed. That is, as described above, the accelerometer generates a signal as it is manipulated by an external force. This signal is output and received at the system (100) receiver (104). In some examples, the signal may be received as radio waves, electromagnetic waves, or via any other transmission mechanism.

In some examples, the features disposed within the object include a micro-electro-mechanical (MEM) accelerometer with radio-frequency (RF) energy harvesting component, plus a transmission device to operate. In other examples, an accelerometer feature disposed within the object may include the accelerometer to sense a movement a battery or other harvesting energy component to power the accelerometer and a transmitter to send an acceleration magnitude signal towards the receiver (104). Each of these components may be disposed within the object and may be connected through conductive traces that are printed into the object.

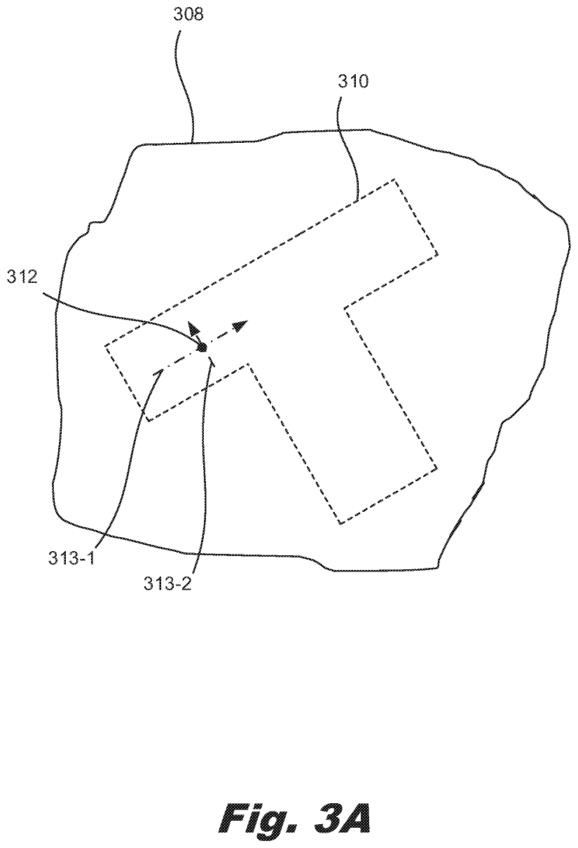

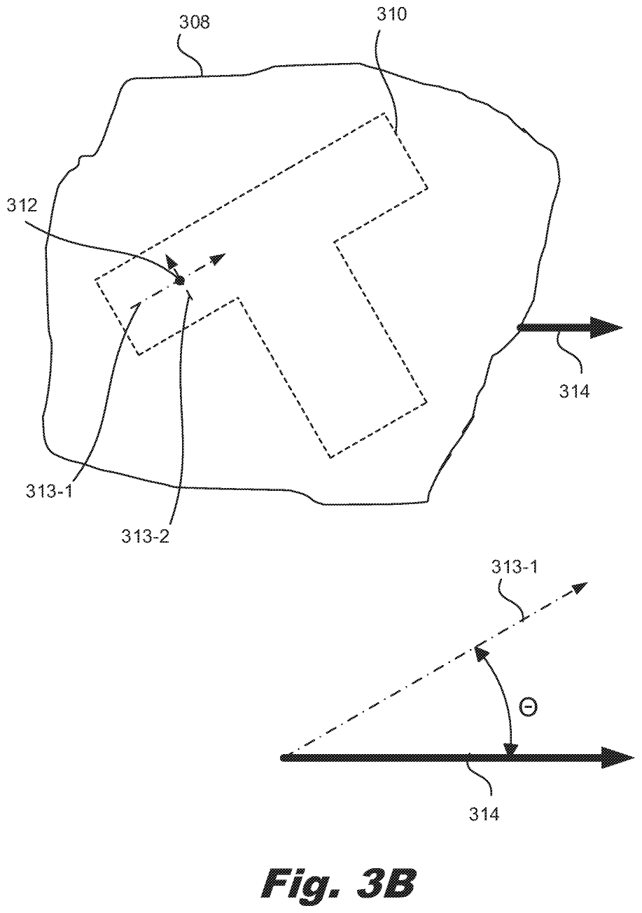

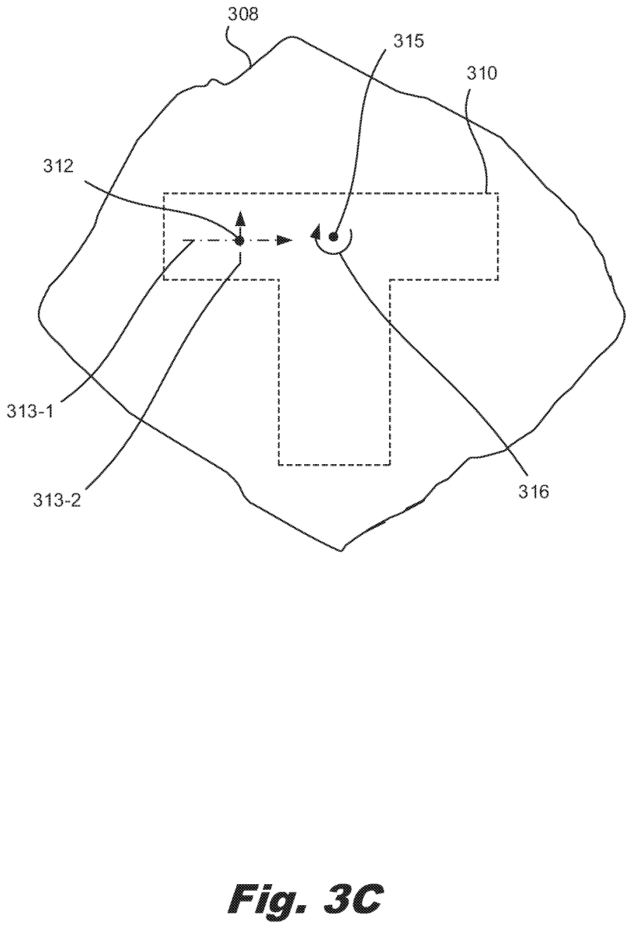

The controller (106) of the system (100) then determines a pose of the object within the mass based on the received accelerometer data. For example, the controller (106) may analyze the output signals received at the receiver (104) against the actual acceleration magnitudes exerted on the object. The difference between the acceleration measured by the accelerometer and the actual acceleration on the mass allows for a determination of the relative pose of the accelerometer within the mass. As the pose of the accelerometer relative to the object is identified, the relative pose of the object within the mass may be determined. That is, knowing the pose of the accelerometer relative to the pose of the mass, and knowing the pose of the accelerometer relative to the object allows for a determination of the pose of the object relative to the pose of the mass. A specific example of determining a pose based on the received accelerometer data, is provided below in connection with FIGS. 3A-3C.

In some examples, the controller (106) accesses a database that includes information on various 3D printed objects that have been made. For example, the database may include a library of dimensions of 3D printed objects. The database may also indicate where, within each 3D printed object, or where within the mass, an accelerometer is disposed. As will be described below, in some examples, the location of the accelerometers within the 3D printed object may be determined by a recorder of an additive manufacturing system, which is distinct from the present system (100) which determines the pose of the 3D printed object within the mass. That is, knowing the exact pose of an accelerometer in the mass, via operation of the system (100), and knowing the exact pose of an accelerometer relative to the object, via the database and a recorder of an additive manufacturing system for example, the exact pose of the object in the mass may be determined. In some examples, if there are multiple accelerometers, the pose of each relative to the 3D printed object may be determined and then three calculations made of the 3D printed object relative to the mass. These different calculations may then be averaged to give a better declaration of the pose of the 3D printed object relative to the mass.

In some examples, the controller (106) controls the movement device (102). That is, the movement device (102) moves the mass based on a control signal from the controller (106). As described above measured acceleration magnitudes are compared against actual acceleration magnitudes. Accordingly, for accurate and precise pose determination, accurate and precise actual acceleration measurements should be carried out. Accordingly, the controller (106) may facilitate a series of systematic motions, or a single complex motion, from which all actual acceleration magnitudes are determined and from which measured acceleration vectors can be calculated.

In addition to determining the pose of the object within the mass, the system (100) may also determine an identifier of an object. That is, each object may have particular dimensions and characteristics that are relevant for downstream processing. This information may be tied to an identifier of the object. Accordingly, by not only identifying the pose of the object within the mass, but identifying the object itself, downstream post-processing operations can be carried out while particular attention is paid to the specific sensitivities that should be in mind when handling the particular part.

In some examples, this identifier may be part of the accelerometer itself. That is, the receiver (104) may receive object identification information from the accelerometer itself. For example, the accelerometer may have a particular energy signal that is detected by the receiver (104). In this example, the received energy signal is passed to the controller (106) which determines an identify of the object based on the received information. For example, the controller (106) may consult the database that has a mapping between energy signals and object identifiers.

In other examples, this identifier may be from a feature separate from the accelerometer. That is, the receiver (104) may receive object identification information from an identifier that is embedded within the object, but that is not the accelerometer. For example, this identifier may have a particular energy signal that is detected by the receiver (104). In this example, the received energy signal is passed to the controller (106) which determines an identity of the object based on the received information. For example, the controller (106) may consult the database that has a mapping between energy signals and object identifiers.

Thus, the present system (100) allows for identification of a pose, that is a six value coordinate such as a displacement along the X axis, a displacement along the Y axis, a displacement along the Z axis, angular rotation about the Z axis, angular rotation about the X axis, and angular rotation about the Y axis, within a mass by receiving measured acceleration magnitudes off of accelerometers disposed within an mass, and by knowing the actual acceleration vectors on the mass itself.

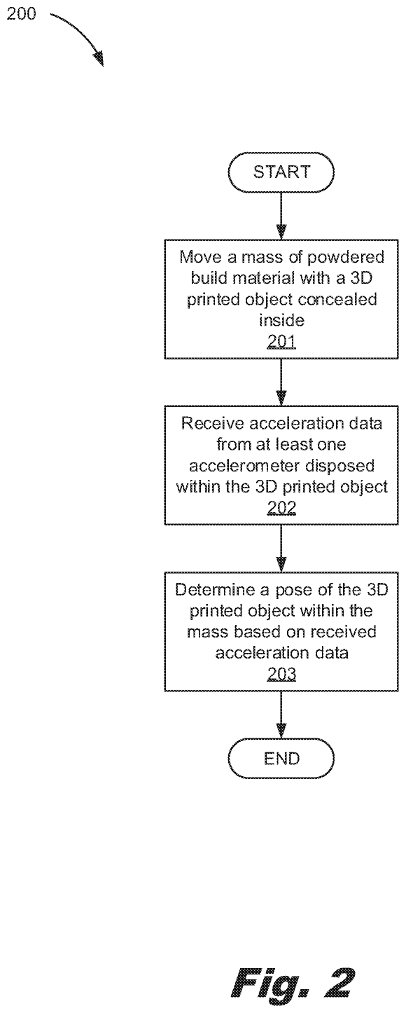

FIG. 2 is a flow chart of a method (200) for accelerometer-based object pose determination, according to an example of the principles described herein. According to the method (200), a mass of powdered build material is moved (block 201). Specifically, the mass of powdered build material conceals a 3D printed object that is to be further processed. The 3D printed object includes accelerometers disposed in, on, or near it. Accordingly, the movement (block 201) of the mass moves the accelerometers which triggers output of a signal from the accelerometers. In some examples, the acceleration magnitude measured by any given accelerometer is different than the acceleration magnitude applied to the entire mass by moving (block 201) it. For example, in FIG. 3A, accelerating the mass (308) directly to the right at 2.3 meters/second² will cause a first accelerometer (312-1) to report a positive acceleration magnitude that is less than 2.3 meters/second². If the angle from a sensitivity axis of the first accelerometer (312-1) differs from the direction of the acceleration vector applied to the mass (308) by 45 degrees, then the first accelerometer (312-1) will report an acceleration of about 1.6 meters/second² as 1.6 approximately equals 2.3×cos(45°).

The relationship between these two acceleration magnitudes can be used to determine a pose of the accelerometer relative to the mass, which along with a predetermined pose of the accelerometer relative to the 3D printed object itself, can be used to determine a component of pose of the 3D printed object relative to the mass.

In some examples, the movement (block 201) may be machine-controlled. That is, precise actual movements (block 201) may be made to ensure that precise “actual” acceleration data is obtained such that measured acceleration data can be accurately compared. That is, were the movements (block 201) imprecise, uncertainty and error would be introduced into the data against which accelerometer-measured information is compared. This uncertainty and error may lead to mis-identification of the pose of the 3D printed object within the mass, which may further result in improper post-processing which could damage the 3D printed part and/or the mechanisms that perform the post-processing.

The output of the accelerometers is received (block 202) at the receiver (FIG. 1, 104) as acceleration data. That is, each accelerometer may generate an output in a variety of forms based on the acceleration vector magnitudes measured at that accelerometer. That output may be received (block 202) and used by a controller (FIG. 1, 106) to determine (block 203) a pose of the 3D printed object within the mass of powdered build material. For example, the controller (FIG. 1, 103) may acquire the received acceleration data, map it to acceleration magnitudes seen by the accelerometers. These measured values are then compared against actual acceleration vector magnitudes applied to the mass itself to determine a difference therebetween. Based on the difference, a pose of the 3D object within the mass is determined. A specific example of pose determination based on measured and actual acceleration data is now provided.

FIGS. 3A-3C depict movement of the mass (308) to determine object (310) pose, according to an example of the principles described herein. As described above, the mass (308) may be powdered build material that for a variety of reasons is semi-permanently “caked” to a 3D printed object (310) that was formed during an additive manufacturing process. The 3D printed object (310) is indicated in uniformly dashed lines to indicate its pose internal to the mass (308).

Also as described above, enclosed within the 3D printed object (310) are any number of accelerometers (312) that output a signal through the material of the 3D printed object (310) and the mass (308) that indicate acceleration magnitudes felt at the locations of each of accelerometer (312). In the example depicted in FIGS. 3A-3C, one accelerometer (312) is disposed within the 3D printed object (310). Such an accelerometer (312) may be a three-axis (313) accelerometer (312) meaning that it detects acceleration magnitudes in three orthogonal directions. Accordingly, the accelerometer (312) may include three sensitivity axes, a first (313-1), a second (313-2), and a third orthogonal to both and in the orientation depicted in FIG. 3A, outward from the page. In other words, an output of this accelerometer (312) may be a vector with three components, each component indicating an acceleration magnitude along each sensitivity axis (313). As described above, and as will be described in more detail below, an accelerometer (312) has a predetermined pose relative to the 3D printed object (310).

As it is hidden inside the mass (308) as depicted in FIG. 3A, the pose of the 3D printed object (310) is unknown to a user or system handling the mass (308). Accordingly, a sequence of precise movements are applied to the mass (308) to determine this pose based on output from the accelerometer (312).

It should be noted that while FIGS. 3A-3C depict a single accelerometer (312), any number of accelerometers (312) may be implemented in accordance with the principles described herein. Moreover, while FIGS. 3A-3C depict the accelerometer (312) placed at a particular location, the accelerometers (312) may be placed at any variety of locations, including having a shared origin. Note that in some examples, additional accelerometers (312) may be used to enhance measurement quality.

In one example, moving the mass of powdered build material includes triggering an automated movement device (FIG. 1, 102) to translate the mass (308) with constant linear acceleration along a first axis (314) in a first plane for an interval as depicted in FIG. 3B. From this value, an acceleration vector experienced by the object (310) and more specifically by the accelerometer (312-1) may be computed. As it is a 3-axis accelerometer (312), the vector may include components relating to each axis (313).

An example is provided of a single axis (313-1) vector component. In this example, the angle, θ, represents the angle between the actual acceleration vector (314) and an acceleration vector component as seen by the accelerometer (312) along a first sensitivity axis (313-1). That is, the mass (308) is accelerated in a predetermined direction. In the case of a 3-axis accelerometer (312) as depicted in FIG. 3B, the system (FIG. 1, 100) reads out the accelerations the accelerometer (312) sees during the acceleration. That is, an acceleration of magnitude A (314) applied to an accelerometer (312) with a sensitivity axis (313-1) positioned at an angle θ with respect to the direction of acceleration A (314) will impart on the respective accelerometer (312) an acceleration with magnitude A*cos(θ) parallel to the sensitivity axis (313-1) for that accelerometer (312).

This angle may be used to determine the rotation of the mass (308) relative to the first axis (313-1). Once θ, and other angles relating to the other sensitivity axes (312) are determined, the mass (308) may be straightened out such that the accelerometer (312) aligns with the first axis (314) and further pose determination movements may be applied.

Thus, in summary, constant linear acceleration can be used by a 3-axis accelerometer (312) to determine the yaw pitch, and roll of the object (310) within the mass (308) relative to the applied acceleration by measuring 3 sensed accelerations and calculating the associated single-vector acceleration acting on the accelerometer (312).

With yaw, pitch, and roll determined, additional movements may be made to determine the x, y, and z position of the accelerometer (312) within the mass (308). Specifically, to determine the position in 2 of the planes, the mass (308) is rotated about an axis in the other plane. For example, In the example depicted in FIG. 3C, an x-axis may be horizontal (left-right), a y-axis may be vertical (up-down), and a z-axis may be into and out of the page. To determine the x and y coordinates of the accelerometer (312), the mass (308) may be rotated about an arbitrary axis (315) parallel to the z-axis at a constant angular rate, ω.

The centripetal acceleration for an object moving in a circular path is defined as a_{c}=ω²*r, where a is the centripetal acceleration, ω is the angular velocity, and r is the radius. The x component of acceleration may be defined as aₓ=ω²*r*cos(θ) and a_{y}=ω²*r*cos(θ). Solving these equations for r, provides the distance from the accelerometer (312) to the arbitrary point (315) such that precise x and y coordinates for the accelerometer (312) may be determined.

To determine the z-coordinate of the accelerometer (312) the mass (308) may be rotated about an arbitrary point orthogonal to the arbitrary point (315). Thus, with these motions, the yaw, pitch, roll, x-coordinate, y-coordinate, and z-coordinate may be determined for the accelerometer (312). As stated above, knowing the pose of the accelerometer (312) relative to the mass (308) and knowing the pose of the accelerometer (312) relative to the object (310) allows for a determination of the pose of the object (310) relative to the mass (308).

Note that while FIGS. 3A-3C depict a sequence of motions relative to one plane, i.e., translation and spinning within the plane, and rotation about an axis of the plane, in some examples complex motions may be performed such as a single motion from which precise poses of one, or all of the orthogonal accelerometers (312) may be determined.

Thus, the exact pose of the accelerometers (312) within the mass (308) is determined. That is, the present system (FIG. 1, 100) and method (FIG. 2, 200) describe how the placement of accelerometers (312) in specific poses relative to a hidden object (310) of interest buried in an obscuring mass (308) are moved, sensed, and used to determine the pose of the object (310) relative to the mass (308) in which it is disposed.

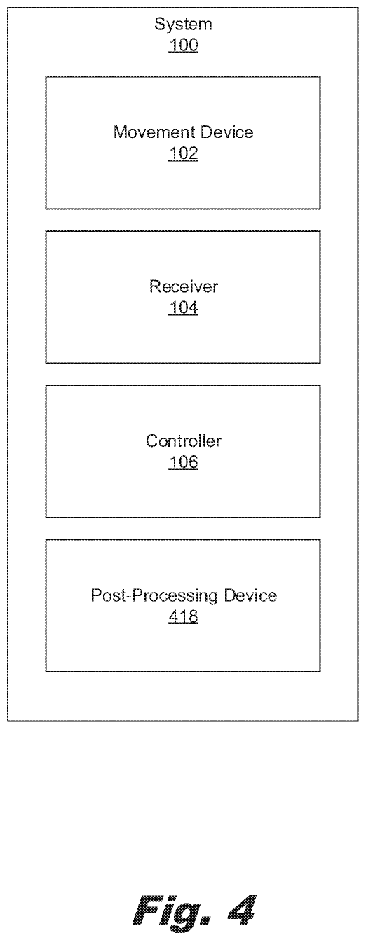

FIG. 4 is a block diagram of a system (100) for accelerometer-based object pose determination, according to another example of the principles described herein. As in the system (100) depicted in FIG. 1, the system (100) depicted in FIG. 4 includes a movement device (102), a receiver (104), and a controller (106).

In some examples, the system (100) includes additional functionality. For example, the system (100) includes a post-processing device (418). In this example, the controller (106) may trigger the post-processing device (418) based on a determined pose and identifier.

For example, the post processing device (418) may be a robotic device that grips the object (FIG. 3A, 310) and/or that cleans the object (FIG. 3A, 310). Such cleaning may be performed by an air stream, a brush, or any number of other cleaning devices. Accordingly, in this example, the controller (106) may trigger object cleaning.

The post processing device (418) may be an object handling operation. For example, once full pose of the object (FIG. 3A, 310) within the mass (FIG. 3A, 308) is determined, a manipulator robot can precisely grasp the 3D printed object (FIG. 3A, 310) appropriately without accidentally damaging it. Accordingly, such a system avoids needing to use a manipulator arm with active force sensors giving feedback from its gripper components.

Then, as described above, the pose can be used to position a cleaning device, such as a sand-blaster, appropriately with respect to the 3D printed object (FIG. 3A, 310) since cake-ablation rate is dependent upon the distance between the sand-blaster and the surface of the object (FIG. 3A, 310). Also, to that end, if the sand-blaster is too close to the surface, especially when it's a delicate object (FIG. 3A, 310), it can ablate away printed part material (not just powder) or can destroy fragile parts or part portions. Accordingly, the operation of determining a pose of the 3D printed object (FIG. 3A, 310) within the mass (FIG. 3A, 308) allows for precise and correct post-processing operations to be executed without damaging the 3D printed object (FIG. 3A, 310) itself.

In an example, the post processing device (418) may be a processor that acquires object-specific data. For example, as described above, a database may exist that includes detailed information on an object (FIG. 3A, 310), such as its dimensions. Such dimensions may be used in subsequent processing. For example, a width of the object (FIG. 3A, 310) may indicate the positioning of a cleaning brush, or may dictate where an air brush is to be positioned to maximize its cleaning effect. Accordingly, the controller (106) may trigger such a retrieval of object-specific data.

As other examples, the post-processing device (418) may perform a machining operation, such as forming holes or joining multiple parts together. In another example, the post-processing device (418) may perform a finishing operation aside from cleaning, such as sanding or polishing. While particular reference is made to a few post-processing operations, the controller (106) may trigger any number and combination of those specific post-processing operations described plus additional post-processing operations. That is, the system (100) by locating and identifying a particular object (FIG. 3A, 310) based on an embedded accelerometer (FIG. 3A, 312) may facilitate precise and delicate post processing operations.

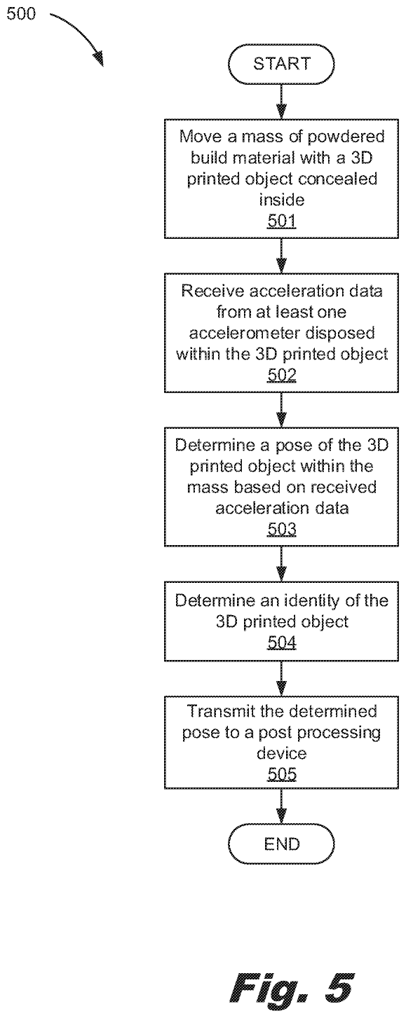

FIG. 5 is a flow chart of a method (500) for accelerometer-based object pose determination, according to another example of the principles described herein. According to the method (500) a mass (FIG. 3A, 308) of powdered build material is moved (block 501) to trigger an output of accelerometers (FIG. 3A, 312) formed in, on, or around an object (FIG. 3A, 310) hidden inside the mass (FIG. 3A, 308). Acceleration data is received (block 502) from the accelerometers (FIG. 3A, 312) and used to determine (block 503) a pose of the 3D object (FIG. 3A, 310) within the mass (FIG. 3A, 308). These operations may be performed as described above in connection with FIG. 2.

As described above, in addition to determining the pose of the object (FIG. 3A, 310) within the mass (FIG. 3A, 308), the system (100) may also determine (block 504) an identifier of an object (FIG. 3A, 310). That is, each object (FIG. 3A, 310) may include an embedded identifier separate from the accelerometer (FIG. 3A, 312) that includes identification information. In other examples, the accelerometers (FIG. 3A, 312) in the objects (FIG. 3A, 310) themselves include the identification information.

In either example, the receiver (FIG. 1, 104) receives an energy signal that can be interpreted, or translated, into an identifier of the object (FIG. 3A, 310). This identifier is passed to a post-processing device (FIG. 4, 418) such that any number of post-processing operations can be performed on the object (FIG. 3A, 310) that are particular to the object (FIG. 3A, 310). In addition to transmitting the determined identity to a post-processing device (FIG. 4, 418), the determined pose of the object (FIG. 3A, 310) is transmitted (block 505) to the post-processing device (FIG. 4, 418). That is, each object (FIG. 3A, 310) may have particular characteristics that justify particular and specific post-processing operations. The identify and pose of the 3D printed object (FIG. 3A, 310) within the mass (FIG. 3A, 308) facilitate these particular and specific operations by allowing any handling device or other post-processing device (FIG. 4, 418) gain access to the specific operation parameters associated with the particular 3D printed object (FIG. 3, 310).

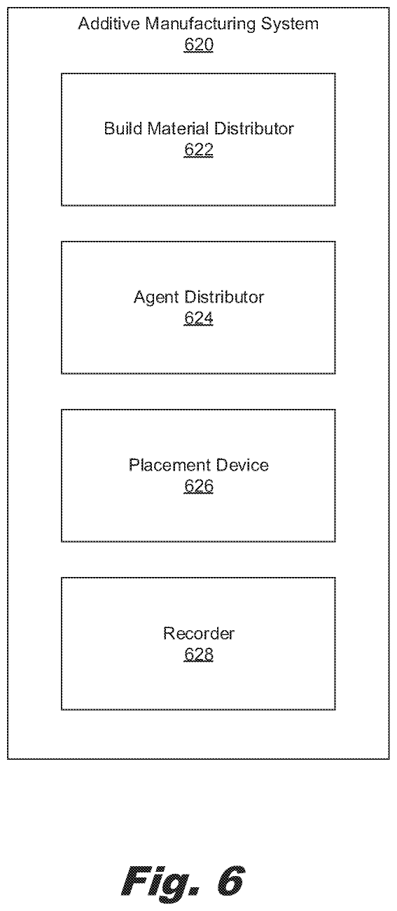

FIG. 6 is a simplified top diagram of an additive manufacturing system (620), according to an example of the principles described herein. In general, apparatuses for generating three-dimensional objects may be referred to as additive manufacturing systems (620). The additive manufacturing system (620) described herein may correspond to three-dimensional printing systems, which may also be referred to as three-dimensional printers.

As described above, in the additive manufacturing process, a fusing agent may be selectively distributed on the layer of build material in a pattern of a layer of a three-dimensional object. An energy source may temporarily apply energy to the layer of build material. The energy can be absorbed selectively into patterned areas formed by the fusing agent and blank areas that have no fusing agent, which leads to the components to selectively fuse together. This process is then repeated until a complete physical object has been formed.

In examples described herein, a build material may include a powder-based build material, where the powder-based build material may include wet and/or dry powder-based materials, particulate materials, and/or granular materials. In some examples, the build material may be a polymer. In some examples, the build material may be a thermoplastic. Furthermore, as described herein, the functional agent may include liquids that may facilitate fusing of build material when energy is applied. The fusing agent may be a light absorbing liquid, an infrared or near infrared absorbing liquid, such as one containing a pigment in aqueous dispersion.

The additive manufacturing system (620) includes a build material distributor (622) to successively deposit layers of the build material onto a bed. In some examples, the build material distributor (622) may be coupled to a scanning carriage. In operation, the build material distributor (622) places build material on the bed as the scanning carriage moves over the bed.

The additive manufacturing system (620) includes an agent distributor (624) to selectively distribute a fusing agent onto layers of the powdered build material to selectively solidify portions of a layer of building material to form a 3D printed object (FIG. 3A, 310). In some examples, the agent distributor (624) is coupled to a scanning carriage that moves along a scanning axis over the bed.

In addition to ejecting the fusing agent, the additive manufacturing system (620) may selectively distribute other agents such as a detailing agent. The ejection of the detailing agent may be by the agent distributor (624) or another distributor. As the fusing agent is used to determine which parts of the powdered build material are to be solidified to form the 3D printed part, the detailing agent is placed on portions of the powdered build material that are not to be solidified or other places for thermal management. That is, the detailing agent can be used to ensure that those portions that are not to form the 3D printed part do not heat up to be either partially, or fully sintered.

An agent distributor (624) may be a liquid ejection device. A liquid ejection device may include at least one printhead (e.g., a thermal ejection based printhead, a piezoelectric ejection based printhead, etc.). In one example, printheads that are used in inkjet printing devices may be used as an agent distributor (624). In this example, the fusing agent may be a printing liquid. In other examples, an agent distributor (624) may include other types of liquid ejection devices that selectively eject small volumes of liquid.

The additive manufacturing system (620) may include other components such as a heater to selectively fuse portions of the build material to form an object (FIG. 3A, 310) via the application of energy to the build material. The heater may be a component that applies energy such as infrared lamps, visible halogen lamps, resistive heaters, light emitting diodes LEDs, and lasers. The heater may apply an amount of energy such that those portions with an increased absorption rate (due to the presence of fusing agent) reach a temperature greater than the fusing temperature while those portions that do not have the increased absorption rate to not reach a temperature greater than the fusing temperature.

The additive manufacturing system (620) also includes a placement device (626) to embed at least one accelerometer (FIG. 3A, 312) in predetermined locations in a mass of powdered build material that includes the 3D printed object (FIG. 3A, 310). The placement device (626) may be a computer-controlled device that precisely places the accelerometers (FIG. 3A, 312) in predetermined locations within the mass.

The placement device (626) may place the at least one accelerometer (FIG. 3A, 312) in a variety of locations relative to the final 3D printed object (FIG. 3A, 310). For example, an accelerometer (FIG. 3A, 312) may be formed on an interior portion of the 3D printed object (FIG. 3A, 310) or on an exterior portion of the 3D printed object (FIG. 3A, 310). In yet another example, the accelerometer (FIG. 3A, 312) is not formed on the 3D printed object (FIG. 3A, 310) at all, but rather is disposed on a portion of the build material that is removed from the 3D printed object (FIG. 3A, 310). That is, the accelerometers (FIG. 3A, 312) may be placed at any location relative to the 3D printed object (FIG. 3A, 310) so long as its pose relative to the object is predetermined. While particular reference is made to formation of a single accelerometer (FIG. 3A, 312), in some examples, the placement device (626) places multiple accelerometers (FIG. 3A, 312) in the build material. For example, the placement device (626) may place three accelerometers (FIG. 3A, 312) on three orthogonal planes of the 3D printed object (FIG. 3A, 310) such that a three-dimensional pose of the 3D printed object (FIG. 3A, 310) may be determined.

In addition to placing the accelerometers (FIG. 3A, 312), the placement device (626) may place other components. Specifically, the placement device (626) may place at least one of an identification chip, a transmitter, and a transmitter power source in predetermined locations in the powdered build material.

As described above, in some examples, the system (FIG. 1, 100) reads an identifier associated with the 3D printed object (FIG. 3A, 310). In some examples, this identifier is read from the identification chip that is placed by the placement device (626).

The system (FIG. 1, 100) relies on accelerometers (FIG. 3A, 312) that can transmit the experienced accelerations to an external receiver (FIG. 1, 104). Accordingly, a transmitter, and a power source for the transmitter may also be embedded on, in, or near the 3D printed object (FIG. 3A, 310) such that this acceleration data can be transmitted out. In some examples, the transmitter may be a short-range transmitter.

The additive manufacturing system (620) also includes a recorder (628) to record a pose of the accelerometer (FIG. 3A, 312) relative to the 3D printed object (FIG. 3A, 310). Note that the recorder (628) is not recording the pose of the 3D printed object (FIG. 3A, 310) inside the mass (FIG. 3A, 308), but is rather noting the predetermined pose of the accelerometer (FIG. 3A, 312) relative to the 3D printed object (FIG. 3A, 310). That is, as described above, the recorded pose of the accelerometer (FIG. 3A, 312) within the 3D printed object (FIG. 3A, 310) facilitates determination of the pose of the 3D printed object (FIG. 3A, 310) within a mass (FIG. 3A, 308) of the powdered build material.

The pose of the accelerometer (FIG. 3A, 312) within the 3D printed object (FIG. 3A, 310) may be recorded in any number of formats. For example, the pose may be indicated by its 6-value location information. That is, the pose may indicate an x, y, and z position relative to a reference point and a yaw, roll, and pitch about three orthogonal axes relative to a reference point. As described above, this precise location of the accelerometer (FIG. 3A, 312) may be recorded and later used to determine the pose of the object (FIG. 3A, 310) within the mass (FIG. 3A, 308).

The characteristics of the accelerometers (FIG. 3A, 312) may also be recorded, such as an output response such that the signals from the accelerometers (FIG. 3A, 312) may be interpreted by the controller (FIG. 1, 104). Such characteristics may include a full 3D spatial resonated signal strength including polarization, all as a function of frequency.

Such systems and methods 1) allow identification of a part, or object, hidden in encompassing material such as a powdered build material; 2) allow for a determination of the pose of a part hidden in the powdered build material; 3) trigger access to precise data associated with a hidden part, such as dimensional data; 4) trigger subsequent cleaning, assembly, or other operations based on the precisely identified part within the mass; 5) conserves build material by not allocating additional build volume for identification and location information; 6) in some examples precludes incorporation of foreign identification device; and 7) can implement any type of accelerometer. However, it is contemplated that the devices disclosed herein may address other matters and deficiencies in a number of technical areas.

What is claimed is:

1. A system for determining a pose of an object within a mass, the system comprising:
a movement device to move the mass with the object disposed therein;
a receiver to receive data from at least one inertial measuring device disposed within the mass in which the object is disposed; and
a controller to, based on received data, determine a pose of the object within the mass.

2. The system of claim 1, wherein:
the receiver receives object identification information from the at least one inertial measuring device; and
the controller determines an identify of the object based on received information.

3. The system of claim 1, wherein:
the receiver receives object identification information from an identifier embedded within the object; and
the controller determines an identify of the object based on received information.

4. The system of claim 1, wherein:
the system comprises a post-processing device; and
controller triggers the post-processing device based on a determined pose.

5. The system of claim 4, wherein the at least one post-processing device performs at least one of:
retrieval of object-specific data;
object cleaning;
a machining operation;
an object handling operation; and
a finishing operation.

6. The system of claim 1, wherein the movement device moves the mass based on a control signal from the controller.

7. A method, comprising:
moving a mass of powdered build material wherein a three-dimensional (3D) printed object is concealed;
receiving acceleration data from at least one accelerometer disposed within the mass of powdered build material as the mass is moved; and
based on the received acceleration data, determining a pose of the 3D printed object within the mass of powdered build material.

8. The method of claim 7, wherein moving a mass of powdered build material wherein a 3D printed object is disposed comprises triggering an automated movement device to:
translate the mass with constant linear acceleration along a first axis in a first plane; and
rotate the mass with respect to an accelerometer axis to determine a radial distance to the accelerometer.

9. The method of claim 8, wherein the translation and rotation of the mass is repeated for each of three orthogonal planes.

10. The method of claim 7, further comprising transmitting the pose of the 3D printed object to a post-processing system.

11. The method of claim 7, further comprising determining, from an identifier embedded in the mass of powdered build material, an identity of the 3D printed object.

12. An additive manufacturing system, comprising:
a build material distributor to deposit layers of powdered build material onto a bed;
an agent distributor to selective distribute a fusing agent onto layers of the powdered build material to selectively solidify portions of a layer of building material to form a slice of a three-dimensional (3D) printed object; and
a placement device to embed at least one accelerometer in predetermined locations in a mass of powdered build material that includes the 3D printed object; and
a recorder to record a pose of the at least one accelerometer relative to the 3D printed object, wherein the recorded pose of the at least one accelerometer within the 3D printed object facilitates determination of the pose of the 3D printed object within a mass of powdered build material.

13. The additive manufacturing system of claim 12, wherein the at least one accelerometer is formed on at least one of:
an interior portion of the 3D printed object;
an exterior portion of the 3D printed object; and
a portion of the powdered build material removed from the 3D printed object.

14. The additive manufacturing system of claim 12, wherein the placement device embeds at least one of an identification chip, a transmitter, and a transmitter power source in predetermined locations in the mass of powdered build material.

15. The additive manufacturing system of claim 12, wherein the placement device embeds three accelerometers on three orthogonal planes of the 3D printed object.
